(19) United States
(12) Patent Application Publication
(10) Pub. No.: US 2007/0219980 A1
(43) Pub. Date: Sep. 20, 2007

(54) Thinking search engines

(76) Inventor: Polycarpe Songfack, (US)

Correspondence Address: POLYCARPE SONGFACK, 10332 SILVER WILLOW DR., SANDY, UT, 84070, US

(21) Appl. No.: 11/384,096

(22) Filed: Mar. 20, 2006

(51) Int. Cl. G06F 17/30

(52) U.S. Cl. 707/5

(57) ABSTRACT

The invention describes Thinking Search Engines, a novel search technology that uses the data representation, problem solving and learning from experience techniques of Thinking Machines of U.S. patent application Ser. No. 11/204,346 by the author. Thinking Search Engines process documents and obtain their subjects in terms of the entities, templates, problems, concerns, solutions, and protocols that they describe whether or not these subjects are explicitly mentioned. They provide an initial ranking of search results by estimating the relative amount of information that each document contains for each of its subjects. During a search session, the machine records various data such as the address of the client machine, the files requested for each search query, the sequence, the elapsed time prior to each request, and the type of action that follows a request in the Session Information Table. Whenever a search session expires, its data is processed to populate the Experience Table of the Thinking Database. In turn, the experience data is used to tune the ranking of resulting files. The Thinking Search Engine also generates sponsoring links that are useful to users without competing with the products and services of the hosting site. Matching topics for sponsoring links are obtained by selecting from the Protocol Table of the Thinking Database all protocols and templates that use those of the hosting sites. Then the protocols and templates of the hosting site are eliminated to avoid competition. The remaining ones are the matching criteria for generating sponsoring links.

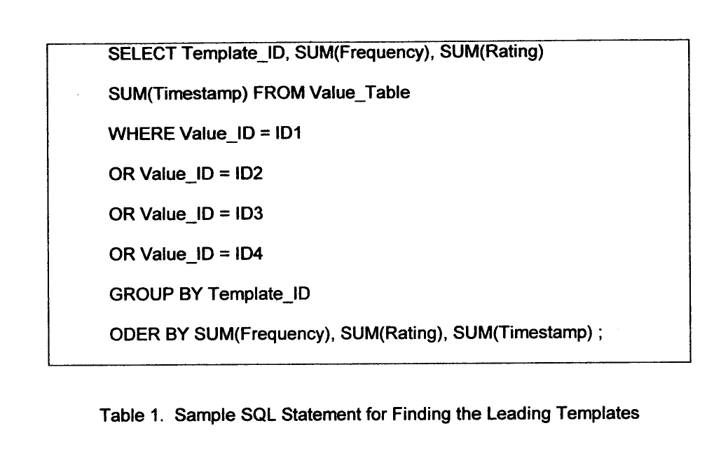

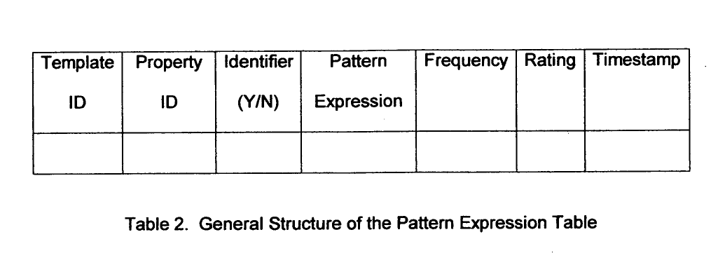

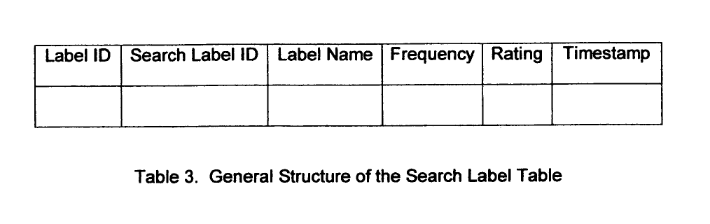

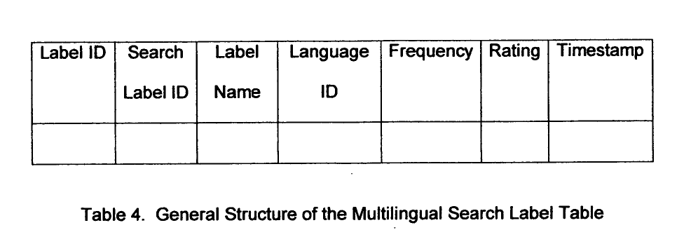

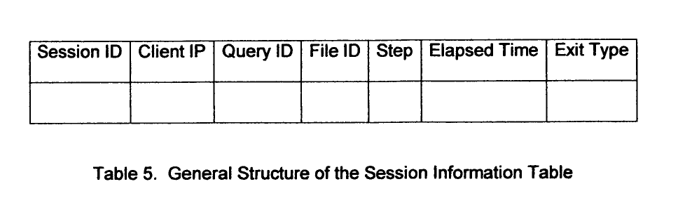

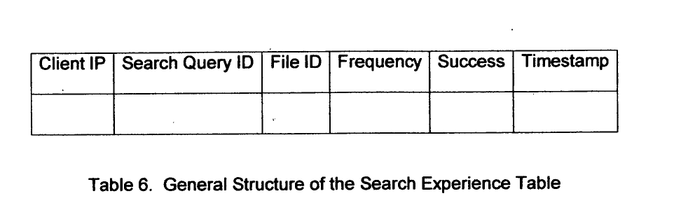

### CROSS-REFERENCE TO RELATED APPLICATIONS

Thinking Machines, U.S. patent application Ser. No. 11/204,346 by the author.

### STATEMENT REGARDING FEDERALLY SPONSORED RESEARCH OR DEVELOPMENT

This invention is not the product of a federally sponsored research.

### BACKGROUND OF THE INVENTION

The rapid increase of the file storage capabilities of Personal Computers coupled with the ease of producing multimedia files, along with the growth of the world-wide-web and other file exchange systems make an incredibly amount of information available to computer users. However, it's becoming harder to find the right information because current desktop, peer-to-peer, and web search engines tend to respond to a search query with a very large number of mostly irrelevant files. This causes users to manually inspect the results, thereby wasting a staggering amount of time. It's imperative to radically improve file search technology in order to alleviate the current information overload.

Several providers have implemented various methods aimed at giving priority to the files that would be the most likely to provide the user with the expected information. Nevertheless, all available search engines share the same basic technique that consists in locating matching files that contain the keywords of the search query. They differ only in the way they determine the order or ranking of the resulting files.

The central issue with available search technology is that the human language generally uses several words to describe a given subject, and so the number of words in a textual document is normally several times the number of subjects. Therefore, each document matches its subjects, but it also constitutes an irrelevant match for numerous other keywords that it only uses to describe its subjects. This constitutes a crucial limitation exploited on a massive scale by web authors who have found that by injecting words in web documents that are not visible to the readers, they can easily manipulate search engines so as to match the pages on their web sites for virtually any search query.

Another important issue is that the human language often uses a combination of words to describe a subject without mentioning the keyword that corresponds to the subject. It is in fact a common practice to completely describe certain entities by stating their identity or exact value without mention of their name, because the value is assumed to be self-describing as it is the case for a color, length, speed, date, zip code, or telephone number for examples. As a result, current search engines would not match a relevant document because it does not contain the query keyword that corresponds to its subject, even though it is described in detail.

Strategies for matching and ordering documents are mainly designed for the hypertext documents of the world-wide-web and rely heavily on their linked structure and the anchor text of multimedia, executables or other non-textual files. Such strategies are not effective for a broad range of applications including desktop searches, multimedia, and other files that are not linked by hypertext documents, file transfer sites, machine generated listings, news, forums and web logs that are not often referenced by other sites.

One popular web search engine uses a ranking system described in Method for node ranking in a linked database, U.S. Pat. No. 6,285,999 dated Sep. 4, 2001. It determines the ranking of a web document based on the number of links pointing to it from other web documents, the ranking of those parent documents and other criteria such as the anchor text of the links, and the fonts of the keywords. According to the authors, the technique reflects the fact that well cited pages from other important sites around the web are worth looking into. One of the shortcomings of this technique is that it lends itself easily to manipulation by web publishers as the owners of pages with high ranking sell or trade links in order to boost the ranking of linked pages. Popular web pages have a high ranking for their subjects, but they also rank high for the auxiliary words used to describe these subjects, thereby polluting the search results of such words. Therefore it is common that a document ranks very poorly in spite of its perfect relevance to the query keywords, because the sponsoring site is not popular from the ranking standpoint that is, in terms of the number of links pointing to it from high-ranking parent pages.

Another ranking system is described in Hypertext document retrieving apparatus for retrieving hypertext documents relating to each other, U.S. Pat. No. 5,848,407, dated Dec. 8, 1998. It estimates the popularity of a hypertext document using anchor sentences of parent documents that have links pointing to it. A related ranking system also based on the popularity of the file is proposed in Method for searching a queued and ranked constructed catalog of files stored on a network, U.S. Pat. No. 5,748,954, dated May 5, 1998. Another ranking approach is described in Method and system for weighting the search results of a database search engine, U.S. Pat. No. 6,182,065, Jan. 30, 2001. This approach divides the set of matching pages into sub-sets and implements a weighting in dependence on the number of links contained in each data entry in each subset to others of the data entries of the corresponding subset. Like the other page-ranking techniques it does not address the central issues because the engine does not understand documents and cannot independently evaluate their relevance to a specific subject.

In the Automated processing of appropriateness determination of content for search listings in wide area network searches, U.S. Pat. No. 6,983,280 dated Jan. 3, 2006, the authors present a method for evaluating candidate data items representing search listings that are submitted for inclusion into a search engine database. The technique consists in checking the candidate document for content that may violate the search site policy, in which case the document is flagged for manual edition. It also verifies that the included links point to existing web pages. It then evaluates the relevance of the document to the search subject using conventional text searching techniques to determine the scores for the title and description fields and its content. The technique is useful for screening out web pages that do not conform to the policy of the search site, and making sure that page submissions match the subject of the search listing to a predetermined extent. The technique provides a way of verifying that web publishers who submit documents for inclusion in directory listings and search engines are not misleading the search engine or polluting its database with undesired content. It does not provide a way of automatically analyzing a document to determine its subjects. It relies instead on web authors to decide the appropriate subjects for their documents, which means that all the documents on the web would have to be manually evaluated and submitted for inclusion. It uses conventional search engines to test the relevance of the document to the search subject, so it is ultimately subjected to the problems of current search engines.

The Combinatorial computational technique for transformation phrase text-phrase meaning, U.S. Pat. No. 6,401,061 of Jun. 4, 2002 proposes a combinatorial system for extracting major meaning components of a phrase or sentence text in natural language and vice versa. It relies on the linguistic elements of a specific language called Semantic Factors consisting in the names or codes for primary, fundamental, or basic concepts. Each Semantic Factor represents a concept that is considered as a simple concept but capable of contributing to describing complicated concepts. Rules are provided for translating the linguistic elements into specially defined set of universal primary or atomic abstract concepts. One major problem with this approach is that each phrase text-phrase is analyzed independently making it difficult if not impossible to evaluate the overall meaning of a document. The other problem is with the use of specifically defined abstract concepts because all the elements of an abstract concept are generally not provided in a phrase because authors only describe some aspects of a concept leaving out others that are defined or may be derived from the context. Finally there is no means of estimating the relative amount of information about a concept provided in a phrase text-phrase, thus it is not very helpful for search engines because the relative importance of two documents with respect to a given subject cannot be estimated. A related technique is provided in the Method and device for parsing and analyzing natural language sentences and text, U.S. Pat. No. 5,721,938 dated Feb. 24, 1998. It also uses semantic labels and as with other available text meaning extraction techniques, it is not well applicable to search engines because it does not ultimately provide a way of estimating the relative amount of information provided in a document about a given subject.

The proposed invention continually adjusts the results of search queries over time based on experience, a feature that is very useful in the case of multimedia, non-textual or others that are not available or suitable for content analysis. Existing methods for improving search results are based on the analysis of log files, or history data that are essentially transient and often discarded from any practical system because they tend to grow in size indefinitely.

A prior art for improving search results with feedback learning is described in Search engine with natural language-based robust parsing for user query and relevance feedback learning, U.S. Pat. No. 6,766,320, dated Jul. 20, 2004. The technique is suitable for complex sentence-based queries to simple keyword searches. Its log analyzer extracts information from the log database to improve the performance over time by training its parser and question matcher. The technique has several drawbacks. It requires the user to explicitly confirm the answers during training. It also relies on log data, which is essentially transient as it grows continually to the point where it needs to be discarded from the system periodically. It also requires periodic analysis of the log data, which may be an intensive process.

Another feedback learning system is presented in Self-learning and self-personalizing knowledge search engine that delivers holistic results, U.S. Pat. No. 6,397,212, dated May 28, 2002. The technique is self-personalizing in that it collects, analyzes user history, generates user profile, patterns of similar users and learns from their reactions. It is also iterative as it provides coarse solution and accepts direct user feedback to improve the next search iteration. Besides the fact that the technique specifically targets business products organized in structured databases, it also requires users to provide with their profile information, which is a serious limitation, as most Internet users would rather protect their private information. It is also an iterative process, so it is not supposed to readily deliver the specific solution in one step. As with other available feedback systems, it explicitly requires user confirmation of the search results. It also uses historical data, which is another form of transient data like the log data. The invention herein uses experience, which is a more practical technique because it is based on permanent knowledge accumulated in a permanent table of predictable size. It records search queries and files requested seamlessly without any extra effort from the user, and is very easy to use without intensive analysis.

An operational issue for search companies is that the engine is often used to generate sponsored links that may be of interest to the visitors a web site, or its search users in order to provide income. It turns out that the sponsoring companies generally provide services that compete with those of the host web site because they match similar keywords. Site operators are therefore left with the choice between supplying sale leads to their competition, or foregoing the search services and the supplemental income of sponsored links. It is desirable to generate sponsoring links that complement instead of competing with the services of the hosting site.

Current search engines cannot address these problems because they do not understand the search queries or the documents. They only match keywords and cannot distinguish between a document that is about a given word and one that only uses it to describe its subjects. They would not understand the purpose of a search or the services provided by a host web site and have no way of identifying competing services, let alone generating complementing ones.

### SUMMARY OF THE INVENTION

Thinking Search Engines are an application of Thinking Machines described in U.S. patent application Ser. No. 11/204,346 by the author. Thinking Search Engines can identify the subjects of search queries as well as textual documents. Such documents use large number of words to provide information about much fewer subjects. Thinking search engines determine the subjects of documents and estimate the relative amount of information that a document provides for each of its subjects. They use that estimate as a basis to locate matching documents, establish their initial ranking, and eliminate a document as a potential match for queries containing words that it only uses as attributes to describe its subjects. The data from each search session contributes to their experience, which in turn is used for adjusting the ranking of textual documents, determining matching multimedia files and their ranking. When the engine is hosted by a web site that provides products or services, it generates sponsoring links of interest that do not compete with such products or services.

Thinking Search Engines represent information in terms of Templates that are sets of properties and associated values, along with frequency of occurrence, rating, and time of last encounter, as explained in the Thinking Machines description. Real world entities are related to they underlying templates by their properties and the corresponding values. These entities may encounter problems that are occurrences of underlying concerns, or may help provide solutions that are implementations of underlying protocols. Textual documents use words that are property names or values to provide information about templates or entities, their associated concerns or problems, and the transactions that are implementing protocols into solutions.

A Thinking search engine evaluates the words in a textual document to determine the templates and entities that it describes using the information from the Template Tables of the Thinking Database. It estimates the relative amount of information provided in the document about an entity or template as the sum of each property value found in the document times the sum of its frequency, rating and time stamp, as given in the Template Tables, weighting each term by an associated factor, divided by the sum over all know properties of the template. Likewise, it uses the information from the Concern Table and Protocol Table to determine the concerns, problems, protocols or solutions depicted in the document. The estimates serve as a basis for determining matching documents for a search query and their initial rankings.

The data from each search session is processed and included in the Experience Table of the Thinking Database whereas the local or remote machine originating the query is the source of the problem, and each matching document is a one-step solution. The Experience Table contains the frequency, rating, and timestamp information of files requested by client machines for each query, and may be used solely or in conjunction with the estimated amount of information in the files to instantly adjust the results of a search.

To generate sponsoring links of interest to the user without competing with the products or services of the site that hosts the Thinking Search Engine, it determines the protocols that include the entities and templates of the search query from the Protocol Table, and eliminate those that are part of the hosting web site or involves its templates or entities. The remaining protocols, entities or templates are ordered according to the associated frequency, rating and time stamp information and used to match the contents of potential sponsoring sites.

### BRIEF DESCRIPTION OF SEVERAL VIEWS OF THE DRAWING

Table 1. Sample SQL Statement for Finding the Leading Template

Table 2. General Structure of the Pattern Expression Table

Table 3. General Structure of the Search Label Table

Table 4. General Structure of the Multilingual Search Label Table

Table 5. General Structure of the Session Information Table

Table 6. General Structure of the Search Experience Table

### DETAILED DESCRIPTION OF THE INVENTION

Introduction

Textual documents use numerous words to describe a few subjects, and cause currently available search engines to produce a very large number of irrelevant results, because they match the keywords of documents instead of the subjects that they describe. Numerous strategies are available to rank the matching documents of a search query in the order of relevance but they are of limited success because of the assumption that the relevance of a document to a given search query is proportional to the popularity of the web site that contains the document. Other strategies use the log data or history information of search query along with user profiles and user confirmation of search results to try and improve the ranking of documents, however it is not practical to request and obtain accurate user profile and confirmation on web sites open to the general public. Also, log data or search history is essentially transient information. It is generally desirable to generate sponsoring links to support the site that hosts the search engine, but such links are normally based on search queries made on the site or its contents and often turn out to be competing products and services.

Samples texts such as the following are encountered routinely in magazines, journals, web pages, and other documents, provide an illustration of the challenges facing search technology:

Sample 1

Pride of ownership abounds in this spacious and remodeled 4 Bedroom, 2.5 Bath, 3 Car Garage Rambler. The kitchen is bright and roomy, with oak cabinetry, tile floors, corner windows and Maytag appliances that stay. It has hardwood floors throughout, two-toned paint, formal dining and oversized living room area with fireplace. Basement has extra-high ceiling and second kitchen. The beautiful backyard has covered patio and curbing. It is a great buy at $349,900. Call Landy at (801) 111-2222.

Sample 2

Must see this 2000 Honda Accord EX V6, 2 door coupe, 70K miles, loaded leader interior, spoiler, sunroof, beautiful inside and out, with new tires, new alternator and chrome wheels, $11,300 OBO. Call Michael at (801) 222-1111 or email michael@somesample2company.com

Although the subjects of both samples are obvious to any human reader, if a separate document is made out of each sample and fed to a search engine, a search query such as “car” would return the first sample because it contains that keyword. A search for “house” would not match any sample as it is not mentioned in those documents, and neither would a query like “for sale”. No matter how powerful the ranking strategy, or the mechanism for feedback and user confirmation, current search technology fails even in such a trivial example.

Numerous textual documents do not mention their subjects because they are obvious to any human reader, and current search technology cannot return such documents among the results of search queries for the subjects of the document. Virtually all documents use a large number of words to describe one or a few subjects, and are matched for several search queries for words for which they do not provide any meaningful information, as they are only use for describing other subjects. Current search technology does not address these problems, and desktop and web search users spend a staggering amount of time sifting through thousands of irrelevant documents, and missing out on some very relevant ones.

Thinking Search Engines constitute a major breakthrough in search technology because they solve existing problems using their ability to understand search queries and textual documents, that is, they determine the entities described in textual documents, the relative amount of information that the document provides about these entities, the problems that they are experiencing or the solutions that they are providing. Without compelling users to any extra step in their search sessions, they improve search results by building up and using experience data, which is stored permanently in a database table of predictable size. Using the knowledge of the entities and problems involved in search queries and documents, they can generate sponsoring links that complement those of the search query or the web site without competition.

Information Representation

Thinking Search Engines represent information in the form of Templates, each composed of a set of properties and corresponding values, along with a frequency of occurrence, a rating that increases when the property is involved in a solution and decreases when it is implicated in a problem, and the time of last encounter. There are very simple templates such as color, telephone number, length, speed and such that only have one property which share its name with the template, and a number of values or value range, each having a different frequency, rating and time stamp. There are also complex templates like car, house, web page, file, computer, and such that have several known properties, each having a frequency, rating and time stamp and a set of values with their own frequencies, ratings and time stamps. Complex templates are actually composed of simpler templates because everything in the system is conceptually a template. The template information is stored in the Template Tables that are composed of a single Property Table and a single Value Table. Those tables have a very unique feature in that they do not store actual data, because all the data is stored in a single Label Table that provides pointers or relations to the other tables. Given a number of arbitrary values, it is always possible to determine the templates that they are associated with, by querying one single table.

Any real world or imaginary entity in the system is related to its underlying template and may be seen as a single state of that template. The information about all these entities is stored in a single Entity Table that contains all the known property values of each entity, and also in the Identification Table that lists the known entities that contain a certain value. It is always possible to query one single table and obtain all the known entities that use a given value, and in reverse, it is always possible to query one table and obtain all the known properties and values of a given entity and determine its underlying template from.

Each entity might have encountered real problems that are stored in the Problem Table. A real problem is actually an occurrence of its underlying Concern stored in the Concern Table. An entity may have been involved in problem solutions that are stored in the Solution Table. A solution is an implementation of its underlying protocol stored in the Protocol Table. Problems, concerns, solutions, protocols and their different steps also have associated frequencies, ratings and time stamps. It is always possible to determine all the potential concerns that may be posed by an entity by querying one single table, and it is always possible to determine all the protocols that it may contribute to the implementation. Actual protocols that have been implemented to provide the solution to known problems are stored in the Experience Table that readily indicates the protocol that is most useful for a given concern.

The label, template, entity, problem, concern, solution, protocol and experience information makes up the Thinking Database. The later is described in detail in the U.S. patent application Ser. No. 11/204,346 by the author, which documents the foundation of Thinking Machines.

Extracting the Meaning of Textual Documents

Textual documents provide information about entities. They describe the state of certain entities, the changes in state caused by actions or transactions with other entities, problems, solutions, and the underlying concerns and protocols. Some entities, actions or transactions might be playing a leading role, while others perform supporting functions.

Understanding the meaning of a document consists in identifying the leading and supporting entities involved, the state changes that it describes and conclude on the actions and transactions that are taking place, the problems, solutions, concerns and protocols implicating those entities.

Since an entity is just one specific state of its underlying template, the information about the entity enables the identification of the template and vice versa. The main objective of the search problem is to identify the templates, and if possible the real life or imaginary entities. The template or entity information enables the identification of the problems and their underlying concerns as well as solutions and their underlying protocols.

Identifying Leading Templates and Transactions

The first step consists in collecting leading text fragments. These are short fragments of text that appear in isolation, highlighted, or specially formatted so as underscore their importance in the document. Such fragments might include titles, section headings, heading sentences of paragraphs, anchor text in links from web pages that point to the document, subject lines and other outstanding short texts.

The next step is to eliminate some of the words from consideration, so as to simplify and accelerate the process. Those are very frequent words that are unlikely to differentiate between templates or entities. Obvious examples are words like “the”, “of”, “and”, and such that are very common. These words or labels are characterized by a very high frequency of occurrence that can be retrieved from the Label Table of the Thinking Database. Labels that have a frequency higher that a certain threshold value are eliminated from further consideration. The actual value of the threshold may vary depending on the implementation. A lower value would increase speed of the process while a higher value would broaden the scope.

The third step is to consider the remaining words, starting with those that have a lower frequency of occurrence because they are most likely to help differentiate between templates. These words are used as criteria to select the Templates where they are encountered from the Value Table portion of Template Tables of the Thinking Database. After considering a few such words, it would turn out that they all point to one or a few templates that are most likely the leading templates of the document. This step may be implemented as simple Standard Query Language (SQL) statement when the Thinking Database is hosted on Relational Database Management Systems (RDMS), or their equivalent when other database systems are in use.

As an example, a document might have Leading Fragments of Text such as: “Objective” “Work History” “Qualification Highlights” “Education” In the case of RDMS, a SQL statement such as the following may be used to identify the Leading Templates as illustrated in Table 1 below where ID1, to ID3 being the Label ID of “Objective”, “Work History”, “Qualification Highlights”, “Education”, obtained from the Label Table. It turns out that after converting the Template ID, we obtain two labels, “Resume” or “Curriculum Vitae” that both designate the same template. From that point the Search Engine knows that the document is a resume, or curriculum vitae, words that are often omitted from such documents.

TABLE 1
Sample SQL Statement for Finding the Leading Templates

SELECT Template_ID, SUM(Frequency), SUM(Rating)
SUM(Timestamp) FROM Value_Table
WHERE Value_ID = ID1
OR Value_ID = ID2
OR Value_ID = ID3
OR Value_ID = ID4
GROUP BY Template_ID
ODER BY SUM(Frequency), SUM(Rating), SUM(Timestamp);

Identifying Supporting Templates

To detect the supporting entities, each leading fragment of text in the document is considered along with the section of normal text that follows or encloses it. As done previously, words that are encountered very frequently are eliminated from further consideration. The least frequent words are then used to select the related templates from the Value Table portion of the Template Tables as seen previously. These templates and the associated entities are playing a supporting role relative to the leading templates and entities found earlier.

Supplying Missing Property Names

Besides obtaining the leading and supporting templates in the document, it is also important to obtain the complete description of these templates and possibly identify the related entities. However, the Value Table only lists the values for the properties that have discrete value sets such as Color, Printing Paper Format, File Type, Car Make, for example. Other properties are not listed because they have a very wide range of values. Examples of such properties are Date, Date Range, Zip Code, URL, Email Address, Telephone Number, Tracking Number, License Plate Number, Social Security Number, Driver License ID, Vehicle Identification Number, Post Office Box Number, Monetary Value or Price. Also, some of these properties are unique identifiers of the related entity. As an example, knowledge of an URL may be enough to pinpoint that exact document on the web, while a date might situate the precise moment of a transaction. The names of properties that have value ranges are obtained using pattern matching techniques in conjunction with the Pattern Expression Table shown in Table 2 below.

TABLE 2
General Structure of the Pattern Expression Table

| | | | | | | |
|---|---|---|---|---|---|---|
| Template | Property | Identifier | Pattern | | | |
| ID | ID | (Y/N) | Expression | Frequency | Rating | Timestamp |

The pattern expressions for the properties of each of the templates found in the previous steps are considered in the order of decreasing frequency and matched against the leading and supporting fragments of texts. When a positive match is obtained, the name of the property is added to the corresponding fragment of text. This technique is very useful because other search engines would not match a query like “price” for example, even though a document states the exact dollar amount, just because the word “price” is not mentioned.

Handling Synonyms

Thinking search engines have a very simple scheme for handling synonyms, by assigning the same Search Label ID in the Label Table to words or frequently use expressions that have the same meaning or may otherwise be interchanged in a textual document. In effect, the issue of synonyms stops at the level of the Label Table and does not require any special processing because all other tables of the Thinking Database use the Search Label ID pointers instead of the words or labels themselves. The resulting structure of the Label Table is shown on Table 3 below.

TABLE 3
General Structure of the Search Label Table

| | | | | | |
|---|---|---|---|---|---|
| | Search | | | | |
| Label ID | Label ID | Label Name | Frequency | Rating | Timestamp |

This scheme is very useful and effective and may be extended to perform searches on documents of different languages without change in any other table or code. This reflects the fact that merely changing the language of a textual document does not affect its meaning or the amount of information that it contains. Table 4 below shows the structure of the Multilingual Search Label Table, which is the same as the previous one with the addition of the Language Identification.

TABLE 4
General Structure of the Multilingual Search Label Table

| | | | | | | |
|---|---|---|---|---|---|---|
| Label | Search | Label | Language | | | |
| ID | Label ID | Name | ID | Frequency | Rating | Timestamp |

Estimating the Relative Amount of Information About a Template

Each fragment of text provides information about a certain number of templates obtained in the previous steps. The Property Table portion of the Template Table lists all the known properties of each template while the textual document may or may not provide the value for all these properties. The Property Table also has the frequency, rating and time stamp information for all the known properties. The relative importance of a known property is the weighed sum of its frequency, rating, and time stamp, each term having a weigh that depends on the implementation. The relative amount of information provided in a fragment of text about a template is therefore the weighed sum of the frequency, rating, and time stamp of the properties for which a value is mentioned in the text, divided by the weighed sum of the frequency, rating, and time stamp of all known properties of the template. Thinking Search Engines use the relative amount of information as the basis for the initial ranking of documents.

Unscrupulous site owners often insert a large number of unrelated keywords in their web pages so that these would match as many search queries as possible and misguide search engines to drive more traffic to their sites. Such practice does not affect Thinking Search Engines because the relative amount of information about unrelated keywords in a document is likely to be insignificant, as their properties and values are not described. Also, inserting unrelated links inside of web pages that rank high for a given query does not help the ranking of such links because the parent page only have a minimal impact on the relative amount information that the linked document contains about a given subject.

Identifying Problems or Concerns

The problems or potential concerns implicating the leading templates of the document are obtained by comparing the property values provided in the text to those that are listed in the Concern Table. A property would be source of a concern when the rating of the value in the text is lower than that of the desired value found in the Concern Table. The relative importance of the concern is the ratio between the ratings of the desired value and that of the value provided in the document.

Solutions and Relative Amount of Information Provided

The Protocol Table of the Thinking Database lists all the known protocols used to devise the solutions to real life or imaginary problems. Each protocol includes one or several steps, each consisting of an action or transaction with a template that has the desired property value. Each step has a frequency of occurrence, success rate and time stamp of the most recent use. Each protocol also has its overall frequency of use, success rate and time stamp information stored in the Experience Table.

The solutions described in the document are obtained by selecting the protocols that contain the templates of the document identified in the previous steps. Since it takes several templates to implement a solution, textual documents use numerous templates to describe fewer solutions. The relative amount of information about a solution is the weighed sum of the frequency, rating and timestamp of each of the step that involves a template described in the document, each term weighted by an appropriate factor, and divided by the weighted sum over all the steps of the protocol.

Using Experience to Improve Search Results

Thinking Search Engines represent each search query as a search problem consisting in finding the file that provides information about the subject of the query. Each matching file is potentially a one step search solution. Textual documents are initially ranked in the order of the relative amount of information about the query as calculated earlier. There are also multimedia files with limited or no metadata available for a meaningful initial ranking. The initial ranking is just the opinion of the search engine, and the users are the ultimate judges of the relevance of a file for a given query. During its lifecycle, a Thinking Search Engines accumulates experience data and uses it to improve search results.

In response to a search query, the Thinking Search Engine shows a sample of each result file in the form of a text segment related to the query, a summary of the document, its title, description, thumbnail image, program screenshot, sample sound, preview movie clip, metadata, or any relevant information that may give the user an idea of the content of the file. Based on the sample information, the user may request a file with a click on its link. The link does not point directly to the document, instead, it points back to the engine such that it has the opportunity to extract the Internet Protocol or IP address of client machine, the file name, session number and time information before redirecting the client to the actual file.

Each search session is identified with a session identification number and lasts between the instant when the client issues the first search request until it expires because there has been a period of inactivity greater than a set maximum. Each session provides with the data shown on the Session Information of Table 5.

TABLE 5
General structure of the Session Information Table

| | | | | | | |
|---|---|---|---|---|---|---|
| Session | Client | Query | | | | |
| ID | IP | ID | File ID | Step | Elapsed Time | Exit Type |

The Elapsed Time is the time since the search session started. The Exit Type gives an idea of how successful a file actually satisfies the needs of the user. After requesting a file, the user may request a different file after a given Elapsed Time, terminate the session, or continue by entering a different query. When the session simply terminates, it is not possible to confirm whether the search was successful or not. In contrast, the nature of the next query is very important because when the next query is unrelated to the previous one, it is likely that the search was successful overall, that is the combination of files that were requested are likely to have provided the information expected. When the next query is reformulated in a way to point to the same template, concern or protocol as the previous one, it means that the previous search was likely unsuccessful. The subject of the following query may also be a complementary template, thereby confirming that the previous search was a success. Thinking Search Engines consider two templates or their related search queries to be complementary when they are involved in different steps of the protocol to solve a given concern. It also means that the client is in the process of solving a larger problem that involves those templates.

As an example, when a query like “resume example” is followed by “resume sample”, it basically means the previous search was not successful, as the client is trying to target the same template. In contrast, if the following query were something like “bread recipe”, the two queries would be unrelated. When the “resume sample” is instead followed by the “job postings”, the two queries are complementary because the related entities both participate the solving a larger problem such as “employment”.

Different weights are assigned to each Exit Type. The success ratio of a file as a response to a query for a given session is estimated as a function of the step at which is was requested, the Elapsed Time since the start of the search, the time difference between the request and the next one if any, and the type of exit. The exact form of that function may change with a specific implementation.

The session data is processed on the fly as soon as the session expires, deleted, and used to populate to the Search Experience Table that has the basic structure of Table 6 below. Depending on the implementation, the Client IP address may be stored as plain text or encrypted for privacy.

TABLE 6
General structure of the Search Experience Table

| | | | | | |
|---|---|---|---|---|---|
| Client | | | | | |
| IP | Search Query ID | File ID | Frequency | Success | Timestamp |

The Search Experience Table is derived from the basic structure of the Experience Table of Thinking Machines and slightly simplified. The Problem ID is now the Query ID, the Solution ID is now the File ID and encapsulates the Entity ID, Property ID, and Value ID that are not used. The Client ID is a new entry. Unlike the history data or the log data of search results that grow continuously and requires to be processed in batch and discarded from the system, the Search Experience Table of the Thinking Database is a permanent table of predictable size. Its maximum size is the number of clients times the number of queries times the maximum number of matching files per query.

When a user initiates a search from a client machine that has provided enough experience data for the search query, a value is calculated for each file that has been requested for that query by the client as the weighted sum of its frequency, rating, and timestamp, each term multiply by a given factor and divided by the weighted sum over all the files requested. The resulting value might be used as the sole criteria for ranking the search results, or it may be used in conjunction with the amount of information about the query in each file.

When there is not enough experience data for the search query from the client IP, the previous calculation is carried out for all the clients. The value for each client machine is then multiplied by a factor representing the weighted sum of the frequency, rating and timestamp of the client machine in the system. The rating of each machine is the number of times that each file that it has requested has been confirmed by other machines, divided by the total number of requests. The overall value of each file for each machine is then summed over all the machines and divided by the total number of machines. The result is use as such or in addition to the amount of information about the query in the file to rank the search results.

Unscrupulous users of the Internet may try to mislead the search engine in attempts to boost the ranking of the files in their domain, by selectively requesting such files regardless of the ranking suggested by the search engine. The experience data is used in a manner such that when a client machine generates garbage information in the system, that information is likely to preferentially pollute the search results for that specific machine. Also the impact of such machines in the results of other clients is marginal because the rating and overall weight of a machine drops when it requests files that are not confirmed by other clients.

Generating Complementary Non-Competing Links

It is a common practice to finance the operation of search engines by adding links to the search result pages that point to the web site of sponsoring companies in order to generate revenue. In some cases, the web site that hosts the search engine uses it to integrate sponsoring links directly into its contents. Often, such sites also sell products or services online. Currently available search engines use the keywords form the search query or the hosting site contents to match the sites of sponsoring companies. That practice poses a problem as it turns out that most sponsors are competitors of the hosting web site because they feature similar goods or services. Thinking Search Engines generate links that are likely to be of high interest to the users of the hosting web site while avoiding competition. Those are complementary non-competing links.

The first step is to determine the templates that correspond to the search query or the contents of the hosting web site. The protocols that use these templates are then selected from the Protocol Table. Each protocol has a frequency and rating and time stamp listed in the Protocol Table and accordingly, the most important one can be obtained. Each protocol also includes several steps and each step involves a different template.

Considering each protocol in turn, the templates implicated in the steps close to the ones involved in the search query or site contents are very likely to be of interest of the user because all those templates are involved of the solution of a larger problem that the user might be in the process of assembling step by step. The templates that match the products or services of the hosting web site are eliminated to avoid competition. The remaining templates are matched against the contents of sponsoring companies. The resulting links complement the products or services of the hosting web site as they collaborate in solving common problems, but they do not compete with such products and services of that site.

I claim:

1. A method for improving search engines performance by identifying the subjects of textual documents, estimating the relative amount of information that they provide about each subject, and using it for the initial ranking of search results, based on the data processing and representation techniques of Thinking Machines of in U.S. patent application Ser. No. 11/204,346 by the author whereas:
(a) The leading text consisting of title, headers, anchor text of linking parent documents, isolated, leading sentences of paragraphs, specifically formatted, labeled, or otherwise outstanding fragments of text, is evaluated against the content of the Template Tables of the Thinking Database.
(b) Very common words whose frequency of occurrence in the Label Table is higher than a threshold value are eliminated from further consideration. Least frequent words of the leading text are compared to the property values of the Value Table to determine possible templates. Those that best fit most of the words in the leading text are the Leading Templates reported in the document.
(c) Considering each leading text and the segment of text following or surrounding it, the Supporting Templates are determined in a manner similar to that of claim (1) (b).
(d) Knowing the templates that the document describe, the Pattern Expression Table is combined with the pattern matching technique to obtain the names of the properties that have a range of values such as phone number, email address, social security number, credit card information, vehicle identifying number, driver's license number, tracking number, dollar amount, zip code, web address and such. These property names are inserted in the text to improve the accuracy of the next step. Some of these values are identifiers and may be used to locate the related real life entities.
(e) The relative amount of information provided about each entity or its underlying template is calculated as the weighted sum of the frequency, rating and timestamp of each of its property listed in the document, weighting each term by a corresponding factor, and dividing by the weighted sum over all known properties of the template. The exact nature of the weighting factor may vary with the implementation. The relative amount of information is used as the base for the initial ranking of documents, alone or in combination with other factors.
(f) The problems and underlying concerns described in the document are located by comparing the property values of the leading templates and entities to those listed in the Concern Table of the Thinking Database. The relative importance of a problem or the corresponding concern is the ratio between the rating of the value provided in the document and that of the value reported in the Concern Table.
(g) The solutions and underlying protocols implemented in the document are found by selecting from the Protocol Table the protocols that involve the leading and supporting templates obtained in claim (1) (a), (1) (b) and (1) (c).
(h) The relative amount of information provided about a given solution or the related protocol is the weighted sum of the frequency, rating and timestamp of each step that involves a template listed in the document, weighting each term by a corresponding factor, and dividing by the weighted sum over all the steps of the protocol. The exact nature of the weighting factor may vary with the implementation. As in claim (1) (e), the relative amount of information is used as the base for the initial ranking of documents, alone or in combination with other factors.
(i) Using the relative information provided in the document about a subject as a based for the initial ranking of search results as described by claim (1) (e), (1) (f), and (1) (h) defeats the common abuse of search engines by web site owners that consists in inserting a plethora of unrelated keywords in their web pages. In effect, the relative information about such keywords is likely to be very insignificant.
(j) The initial ranking of search results of claim (1) (e), (1) (f), and (1) (h) also eliminates a popular technique consisting of misleading search engines by inserting unrelated links inside of higher ranking pages because the parent page only have a minimal impact on the relative amount information that the linked document contains about a given subject.
(k) The synonym problem is implicitly solved by assigning a common Search Label ID in the Search Label Table to all the words, search queries, and frequently used expressions that share common meaning, or designate the same in the remaining tables of the Thinking Database. Since these tables only use pointers from the Search Label Table, no further processing is needed for handling synonyms.
(l) A similar scheme to that of claim (1) (i) is used for processing documents of other languages with the addition of the Language ID field in the Multilingual Search Label Table of the Thinking Database.

2. A method for improving search engine performance for textual documents and non-textual multimedia files by considering each search query as a problem and each matching file as a one-step solution, then learning from experience as Thinking Machine whereas:
(a) In response to a search query, the user is presented with a sound sample, thumbnail image, video preview, software screenshot, summary, description, title, name, or any extract that gives an idea of the content of each result file along with a link for requesting it from to search engine.
(b) Upon clicking on the link, the search engine extracts information such as the client machine IP address, session ID, the search query ID, and the requested file ID before showing it to the user. The search session information is processed whenever the session expires and the data is used to populate the Experience Table of the Thinking Database. Depending on the implementation, the Client IP address may be stored in plain text or encrypted for privacy.
(c) When a user initiates a search from a client machine that has provided enough experience data for the search query, a value is calculated for each file that has been requested in the past for that query by the client as the weighted sum of its frequency, rating, and timestamp, each term multiply by a given factor and divided by the weighted sum over all the files requested for the query. The resulting value might be used as the sole criteria for ranking the search results, or it may be combined with the amount of information about the query in each file, and other factors.
(d) Ranking the result files for each client machine based on its own previous input data as in claim (2) (c) ensures that the search engine tunes the results to the preferences of each client. Also, clients that have provided junk data in the system are likely to have distorted their own search results.
(e) When there is not enough experience data for the search query from the client machine, the calculation of claim (2) (c) is performed over all the client machines that have carried out a search for that query. The value for each client machine is then multiplied by a factor representing the weighted sum of the frequency, rating and timestamp of the client machine. The rating of a machine is the number of times that each file that it has requested for a given query has been confirmed by other machines, divided by the total number of requests. The overall value of each file for each machine is then summed over all the machines and divided by the total number of machines. The result is use as such, or in addition to the amount of information about the query in the file, and other factors to rank the search results.
(f) Weighting the result of each machine by its own frequency, rating and timestamp as in claim (2) (d) data lowers the impact of machines that have introduced bad data in the system.

3. A method for generating sponsored links of interest to the users of a web site hosting the search engine that do not compete with its products or services, using the problem solving techniques of Thinking Machines whereas:
a) The content of the web site or search query is evaluated as described in claim (1) to obtain information about the entities and underlying templates, problems and underlying concerns, solutions and underlying protocols involved in the web site or search query. The entities and solutions are the products and services of the site that hosts the search engine.
b) The engine then selects from the Protocol Table of the Thinking Database all the protocols that involve the templates and underlying entities of claim (3) (a), and the associated concerns. These protocols include those of claim (3) (a), as well as many others. In order to not compete with the hosting web site, the templates, protocols, and concerns of claim (3) (a) are eliminated from consideration and the remaining are retained.
c) The templates, protocols, and concerns retained in claim (3) (b) have additional information in terms of frequency, rating and time stamp. That information is used as ranking criteria, enabling the engine to pick the most likely to be of interest to the user. They are then use as search query for matching sponsoring links that do not compete with the hosting web site. The sponsoring companies provide products and services that complement instead of competing with the hosting web site.
